(19) United States
(12) Patent Application Publication
(10) Pub. No.: US 2008/0175022 A1
(43) Pub. Date: Jul. 24, 2008

(54) ILLUMINATING UNIT

(76) Inventors: Takuro Sugiura, Fukushima-ken (JP); Heishiro Fudo, Kukushima-ken (JP); Toshimitsu Kuroki, Fukushima-ken (JP); Ikuo Hibino, Fukushima-ken (JP); Atushi Yoshida, Fukushima-ken (JP); Katsuyuki Katayama, Fukushima-ken (JP); Hironobu Watanabe, Fukushima-ken (JP)

Correspondence Address: BRINKS HOFER GILSON & LIONE, P.O. BOX 10395, CHICAGO, IL, 60610, US

(21) Appl. No.: 11/961,768

(22) Filed: Dec. 20, 2007

(30) Foreign Application Priority Data
Jan. 22, 2007 (JP) 2007-011066
Feb. 6, 2007 (JP) 2007-026218
Feb. 16, 2007 (JP) 2007-036590

(51) Int. Cl. F21V 7/04

(52) U.S. Cl. 362/609

(57) ABSTRACT

Disclosed is an illuminating unit capable of effectively introducing light emitted from a light source into a light guide sheet to improve the brightness of light and emitting uniform color light. Light emitted from a light emitting diode of a light source unit is incident on a side surface of a light guide sheet. A spacer aligns the emission center of the light emitting diode with the center of the light guide sheet in the thickness direction thereof. The incident light travels in the light guide sheet and is then diffused in light emitting regions provided on the main surface of the light guide sheet. Then, the diffused light is emitted to the outside. In addition, light components emitted from a gap between the light emitting diode and the side surface of the light guide sheet or light components emitted from the upper surface of the light source unit to the outside are reflected to the light guide sheet by a cover member.

### CLAIM OF PRIORITY

This application claims benefit of the Japanese Patent Application Nos. 2007-011066, 2007-026218, and 2007-036590 filed on Jan. 22, Feb. 6, and Feb. 16, 2006, respectively, the entire contents of which are hereby incorporated by reference.

### BACKGROUND

1. Field of the Invention

The present invention relates to an illuminating unit that illuminates an operation region of a portable terminal such as a mobile phone.

2. Description of the Related Art

Surface light sources that emit light from a rear side of a liquid crystal display panel to a front side thereof, such as backlight devices, have been proposed as illuminating units for display devices, such as liquid crystal display devices. For example, this type of backlight device is disclosed in JP-A-2003-298119. As disclosed in JP-A-2003-298119, the thickness of a light emitting diode, which is a light source of the backlight, is substantially equal to or larger than that of a wiring substrate.

Further, for example, JP-A-2000-123620 discloses a surface light source including a light guide plate that guides light emitted form a light emitting diode, and a transparent film formed on the light guide plate. The transparent film has a fluorescent material that receives light guided by the light guide plate and produces fluorescence and an uneven surface. In the surface light source, when light emitted from the light emitting diode is incident on the fluorescent material, the fluorescent material produces fluorescence, and the fluorescence is emitted to the outside through the uneven surface.

In recent years, light guide sheets have been developed to guide light emitted from the above-mentioned surface light source to illuminate an operation region of a portable terminal such as a mobile phone. Since the light guide sheet is disposed on the operation region of the portable terminal, the light guide sheet needs to have flexibility for a user to reliably operate the portable terminal, and also needs to have a small thickness. Since the thickness of the light guide sheet is smaller than that of the light emitting diode, which is a light source, it is necessary to maximize the amount of light incident on the light guide sheet from the light emitting diode.

Further, the light guide sheet is generally formed of a plastic material. When light emitted from the light emitting diode is incident on the light guide sheet formed of a plastic material by the above-mentioned method, a specific light component is absorbed by the light guide sheet, which makes it difficult to emit uniform color light from the entire surface of the light guide sheet according to the position of the light source.

### SUMMARY

An illuminating unit includes: a base; a light guide sheet that includes a main surface and a side surface, and is provided on the base directly or with a predetermined sheet interposed therebetween; a light source that is disposed in the vicinity of the side surface of the light guide sheet; and a cover member that is provided so as to cover at least a gap between the light source and the side surface of the light guide sheet, and reflects, to the light guide sheet, light components that are not incident on the side surface of the light guide sheet.

According to the above-mentioned structure, when light emitted from the light source is incident on the side surface of the light guide sheet and travels in the light guide sheet, light components emitted from the gap or light components emitted from the upper surface of the light source to the outside are reflected from the cover member to the light guide sheet. Therefore, it is possible to effectively guide light emitted from the light source to the light guide sheet. As a result, the brightness of light emitted from the illuminating unit is improved.

In the illuminating unit according to the above-mentioned aspect, preferably, the cover member includes a light absorbing layer that absorbs the light components that are not incident on the side surface of the light guide sheet.

Further, an illuminating unit according to another embodiment includes a base having an operation region, a light guide sheet that includes a main surface and a side surface and is provided on the base directly or with a predetermined sheet interposed therebetween, a light source that is disposed in the vicinity of the side surface of the light guide sheet, and a spacer that is provided between the light guide sheet and the base and has a sufficient thickness to align an emission center of the light source with the center of the light guide sheet in the thickness direction thereof. According to this structure, it is possible to optimally align the light source with the light guide sheet, and thus improve the brightness of light.

Further, the light guide sheet includes a sheet body, a main surface, and a side surface. A plurality of light emitting regions are provided on the main surface of the sheet body to emit light that is incident from the side surface. The light emitting regions are formed of a reflective material that contains a correcting material having a color corresponding to the color of light absorbed by a material forming the sheet body. Therefore, it is possible to emit uniform color light from the entire surface of the light guide sheet regardless of the position of the light source.

### BRIEF DESCRIPTION OF THE DRAWINGS

FIG. 1 is a diagram illustrating an illuminating unit without a structure according to the disclosure;

FIGS. 2A and 2B are a side view and a plan view illustrating an illuminating unit according to an embodiment of the disclosure, respectively;

FIGS. 3A to 3D are diagrams illustrating a cover member of the illuminating unit according to the embodiment;

FIGS. 4A to 4C are diagrams illustrating a light source unit of the illuminating unit according to the embodiment;

FIGS. 5A to 5C are diagrams illustrating the light source unit of the illuminating unit according to the embodiment;

FIG. 6 is a diagram illustrating another example of the illuminating unit according to the embodiment;

FIGS. 7A and 7B are diagrams illustrating another example of the illuminating unit according to the embodiment

FIG. 8 is a diagram illustrating an illuminating unit according to another embodiment of the disclosure;

FIG. 9A is a side view illustrating another example of the illuminating unit according to another embodiment, and FIG. 9B is a partial enlarged view of FIG. 9A;

FIG. 10 is a graph illustrating the relationship between the angel θ of an inclined plane of a spacer and brightness;

FIG. 11 is a partial enlarged view illustrating another example of the illuminating unit according to another embodiment;

FIGS. 12A and 12B are a plan view and a partial side view illustrating a light guide sheet according to still another embodiment, respectively;

FIG. 13 is a graph illustrating the relationship between chromaticity and the distance from a light source;

FIG. 14 is a chromaticity table illustrating a variation in chromaticity shown in FIG. 13;

FIG. 15 is a graph illustrating the relationship between chromaticity and the content of a correcting material in a reflective material;

FIGS. 16A to 16D are diagrams illustrating the ratio of a correcting material to a reflective material in a light emitting region; and

FIG. 17 is a diagram illustrating another example of the light guide sheet according to still another embodiment.

### DESCRIPTION OF THE EMBODIMENTS

Hereinafter, exemplary embodiments of the invention will be described in detail with reference to the accompanying drawings.

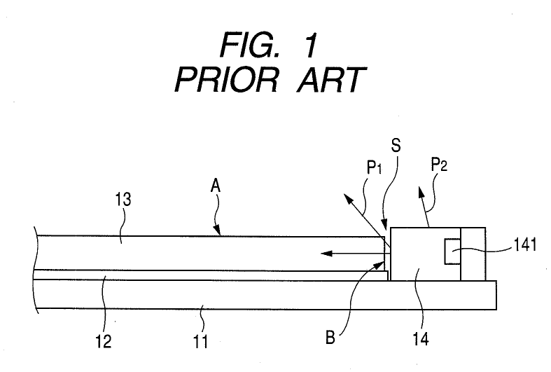

FIG. 1 is a diagram illustrating an illuminating unit without a structure according to the invention. The illuminating unit shown in FIG. 1 includes a base 11 having an operation region. The structure of the operation region of the base 11 is not particularly limited. A contact sheet 12 is provided on the base 11. The contact sheet 12 is formed of a plastic material, such as PET (polyethylene terephthalate) resin.

A light guide sheet 13 is provided on the contact sheet 12. A light source unit 14 is provided in the vicinity of a side surface B of the light guide sheet 13. The light source unit 14 is provided with a light emitting diode (LED) 141 serving as a light source. It is necessary to reduce the thickness of the light guide sheet 13 in order to reliably perform an operation (for example, an operation of pushing a button) in the operation region. Therefore, the thickness of the light guide sheet 13 is smaller than that of the light source unit 14.

The light guide sheet 13 includes a main surface A and the side surface B, and is formed of a flexible material such as plastic. Specifically, the light guide sheet 13 is formed of polyurethane resin, PET (polyethylene terephthalate) resin, PEN (polyethylene naphthalate) resin, silicon resin, polyolefin resin, or acrylic resin.

A gap S is formed between the light source unit 14 and the side surface B of the light guide sheet 13. It is very difficult to completely remove the gap S. Among light components emitted from the light source unit 14, a light component P1 that is not incident on the side surface B of the light guide sheet 13 is emitted from the gap S to the outside, as shown in FIG. 1. In addition, a light component P2 is emitted from the upper surface of the light source unit 14 to the outside. Since the light components P1 and P2 are not incident on the light guide sheet 13, they do not contribute to improving the brightness of light emitted from the illuminating unit, which results in a reduction in the brightness.

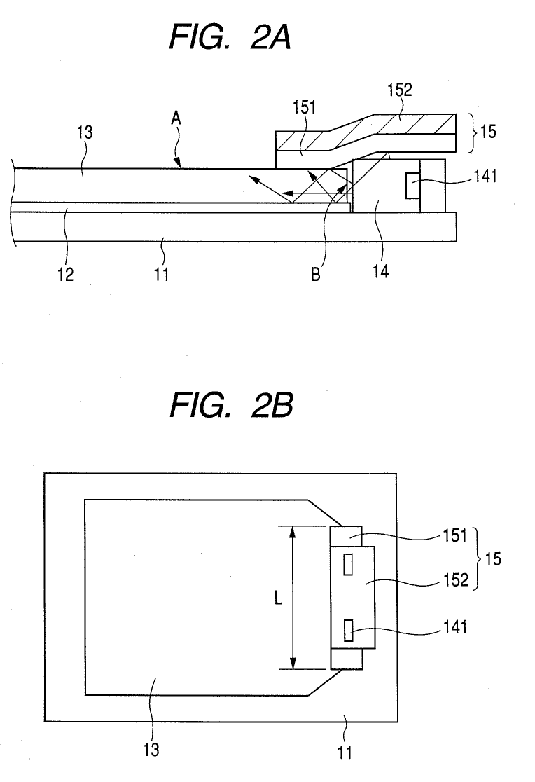

FIGS. 2A and 2B are diagrams illustrating an illuminating unit according to an embodiment of the invention. Specifically, FIG. 2A is a side view illustrating the illuminating unit, and FIG. 2B is a plan view illustrating the illuminating unit. In the illuminating unit shown in FIGS. 2A and 2B, a cover member 15 is provided so as to cover at least the gap S between the light source unit 14 and the side surface B of the light guide sheet 13. The cover member 15 also covers the upper surface of the light source unit 14. The cover member 15 reflects, to the light guide sheet 13, light components that are not incident on the side surface B of the light guide sheet 13, that is, the light component P1 emitted from the gap S and the light components P2 emitted from the upper surface of the light source unit 14 to the outside, as shown in FIG. 1

Light emitted from the light emitting diode 141 provided in the light source unit 14 is incident on the side surface B of the light guide sheet 13 and travels inside the light guide sheet 13. The light traveling inside the light guide sheet 13 is diffused in light emitting regions provided on the main surface A (a main surface opposite to the base 11) of the light guide sheet 13 and then emitted to the outside. The light component emitted from the gap S or the light component emitted from the upper surface of the light source unit 14 to the outside is reflected from the cover member 15 to the light guide sheet 13. Therefore, it is possible to effectively guide light emitted from the light source unit 14 to the light guide sheet 13. As a result, the brightness of light emitted from the illuminating unit is improved.

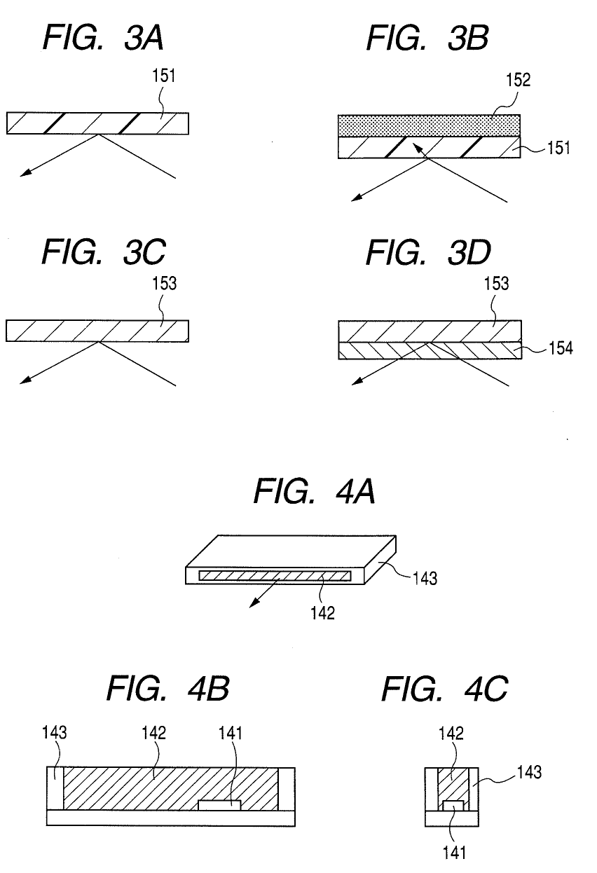

The structure of the cover member 15 is not particularly limited as long as it can guide light leaking from the light guide sheet 13 to the light guide sheet 13. As shown in FIG. 3A, the cover member 15 may include only a light reflecting layer 151. Alternatively, as shown in FIG. 3B, the cover member 15 may include a light absorbing layer 152 provided on the light reflecting layer 151. In particular, when the light absorbing layer 152 is provided on the light reflecting layer 151, as shown in FIG. 3B, it is possible to absorb light passing through the light reflecting layer 151, and thus reliably prevent the leakage of light to the outside. As a result, when the illuminating unit according to this embodiment is mounted to an apparatus, it is possible to prevent the leakage of light from a case of the apparatus. In this structure, for example, a white resin layer may be used as the light reflecting layer 151, and a black resin layer or a black tape may be used as the light absorbing layer 152. In addition, as shown in FIG. 2B, the length L of the light reflecting layer 151 is preferably larger than the width of the light source unit 14. In this way, it is possible to reliably guide light leaking from the light guide sheet 13 to the light guide sheet.

As shown in FIG. 3C, the cover member 15 may be formed of a metal layer 153, and as shown in FIG. 3D, the cover member 15 may include a transparent resin layer 154 provided below the metal layer 153. As shown in FIG. 3D, when the transparent resin layer 154 is formed, it is possible to reliably prevent the short circuit between the metal layer 153 and wiring lines of the light source unit 14.

FIGS. 4A to 4C are diagrams illustrating a light source unit of the illuminating unit according to this embodiment. Specifically, FIG. 4A is a perspective view illustrating the light source unit, FIG. 4B is a front view illustrating the light source unit, and FIG. 4C is a side view illustrating the light source unit. In the light source unit shown in FIGS. 4A to 4C, the light emitting diode 141 is provided in a transparent resin layer 142, and a reflector 143 is provided around the transparent resin layer 142. In the light source unit 14 having the reflector 143, light is emitted from the light emitting diode 141 through an opening where the reflector 143 is not formed, as shown in FIG. 4A, and thus it is not necessary to consider light emitted from the upper surface of the light source unit 14. Therefore, the cover member 15 is preferably provided so as to cover the gap S between the light source unit 14 and the side surface B of the light guide sheet 13. The cover member 15 may not cover the upper surface of the light source unit 14.

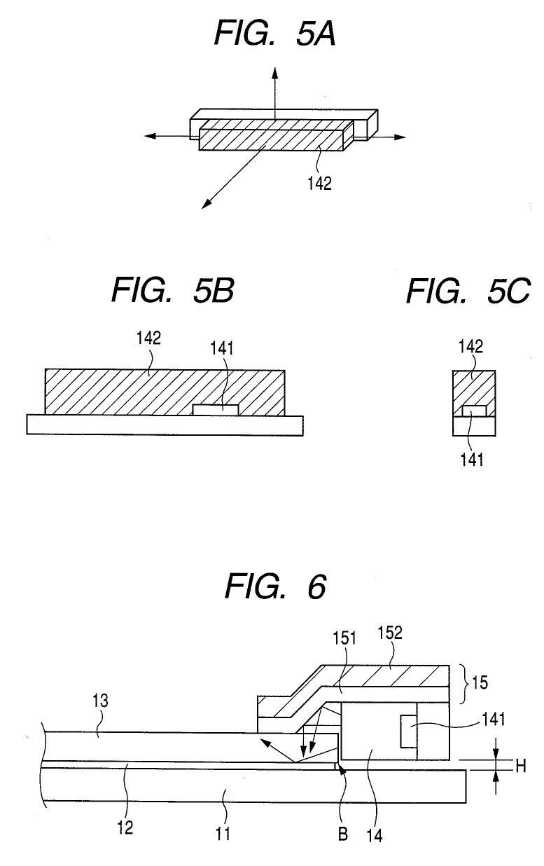

FIGS. 5A to 5C are diagrams illustrating the light source unit of the illuminating unit according to this embodiment. FIG. 5A is a perspective view illustrating the light source unit, FIG. 5B is a front view illustrating the light source unit, and FIG. 5C is a side view illustrating the light source unit. In the light source unit shown in FIGS. 5A to 5C, the light emitting diode 141 is provided in the transparent resin layer 142, but the reflector is not provided. In the light source unit 14, as shown in FIG. 5A, light is emitted from the light emitting diode 141 in four directions, and thus it is necessary to reflect light emitted from the upper surface of the light source unit 14 to the light guide sheet 13 using the cover member 15. Therefore, it is necessary to provide the cover member 15 so as to cover both the gap S between the light source unit 14 and the side surface B of the light guide sheet 13 and the upper surface of the light source unit 14. In the light source unit 14 shown in FIGS. 5A to 5C, some light components are emitted from the surface of the base 11 in a substantially vertical direction thereof (light components are emitted from the upper surface of the light source unit 14), which may cause the brightness of light emitted from the illuminating unit to be non-uniform. As described above, the cover member 15 covering both the gap S between the light source unit 14 and the side surface B of the light guide sheet 13 and the upper surface of the light source unit 14 makes it possible to improve the uniformity of the brightness of light emitted from the illuminating unit.

When the light source unit 14 is mounted on the base 11, the light source unit 14 is inevitably lifted up from the base 11, as shown in FIG. 6. The lift H of the light source unit 14 from the base 11 is in a range of about 0.01 mm to about 0.09 mm when the light source unit 14 is mounted on the base 11. When the light source unit 14 is lifted, as shown in FIG. 6, the positional relationship between the light source unit 14 and the light guide sheet 13 varies, that is, the center of the light source unit 14 in the thickness direction thereof becomes distant from the center of the light guide sheet 13 in the thickness direction thereof, which makes it difficult for light emitted from the light source unit 14 to be effectively incident on the side surface B of the light guide sheet 13. As a result, the brightness of light emitted from the illuminating unit is likely to be lowered.

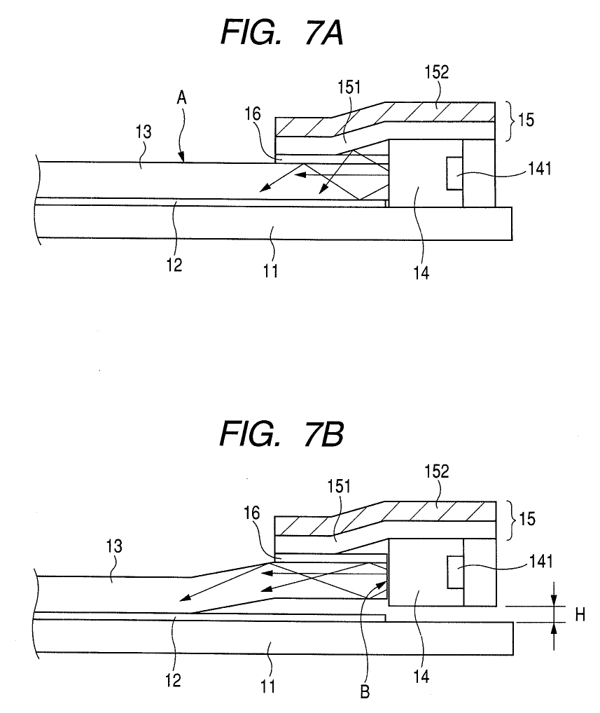

For this reason, it is preferable that the cover member 15 be adhered to the main surface A of the light guide sheet 13 by an adhesive. That is, as shown in FIG. 7A, an adhesive layer 16 is interposed between the main surface A of the light guide sheet 13 and the cover member 15. In this structure, when the light source unit 14 is mounted on the base 11 and is then lifted up from the base 11, the cover member 15 is also lifted. Since the cover member 15 is adhered to the main surface A of the light guide sheet 13 with the adhesive layer 16 interposed therebetween, the light guide sheet 13 is also lifted when the cover member 15 is lifted up. Therefore, as shown in FIG. 7B, the positional relationship between the light source unit 14 and the light guide sheet 13 does not vary, that is, the distance between the center of the light source unit 14 in the thickness direction thereof and the center of the light guide sheet 13 in the thickness direction thereof is not changed. As a result, light emitted from the light source unit 14 can be effectively incident on the side surface B of the light guide sheet 13, which makes it possible to prevent the brightness of light emitted from the illuminating unit from being lowered.

Next, another embodiment of the disclosure will be described in detail with reference to the accompanying drawings.

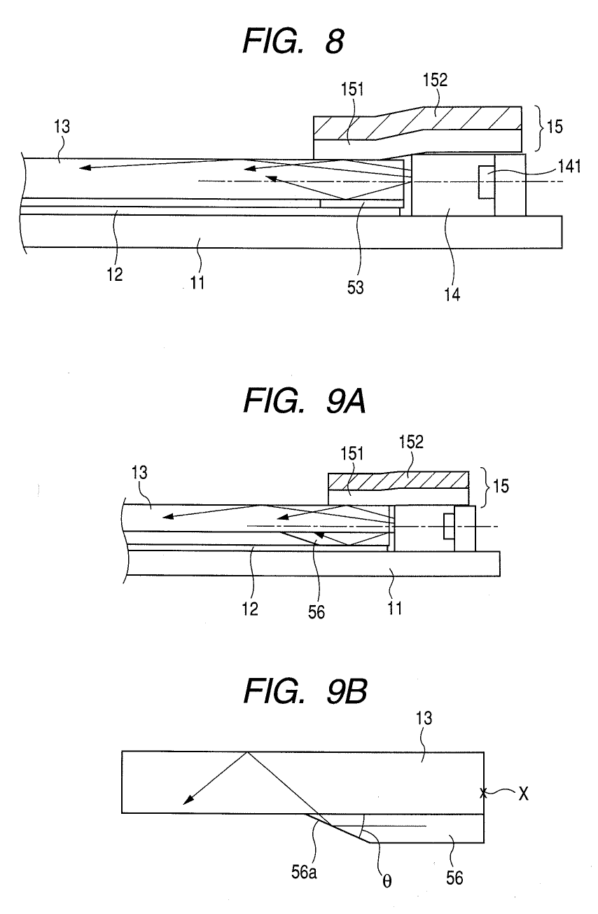

FIG. 8 is a diagram illustrating an illuminating unit according to another embodiment of the disclosure. In this embodiment, the same components as those shown in FIGS. 1 to 7 are denoted by the same reference numerals, and a detailed description thereof will be omitted.

A light guide sheet 13 is provided on a contact sheet 12 with a spacer 53 interposed therebetween. That is, the spacer 53 is provided between the light guide sheet 13 and the base 11, and the contact sheet 12 is interposed between the spacer 53 and the base 11. In addition, light emitting regions (not shown) formed of a reflective material are provided on the light guide sheet 13.

The spacer 53 is provided in order to align the emission center of the light emitting diode 141, serving as a light source, with the center of the light guide sheet 13 in the thickness direction thereof. The spacer 53 has a sufficient thickness to align the emission center of the light emitting diode 141 with the center of the light guide sheet 13 in the thickness direction thereof. Therefore, the thickness of the spacer 53 is appropriately set in consideration of the thickness of the light guide sheet 13 and the emission center of the light emitting diode 141 provided on the base 11. The spacer 53 has a white color. In this way, it is possible to effectively reflect light and thus effectively guide light into the light guide sheet 13. In this case, the spacer 53 may be formed of, for example, acrylic resin, PET resin, silicon resin, or ABS resin.

In the illuminating unit having the above-mentioned structure, since the spacer 53 aligns the emission center of the light emitting diode 141 with the center of the light guide sheet 13 in the thickness direction thereof, light emitted from the light emitting diode 141 can be effectively incident on the light guide sheet 13. As a result, it is possible to effectively use light emitted from the light emitting diode 141 to illuminate the light emitting regions, and thus improve the brightness of light emitted from the light emitting regions.

When the spacer 53 aligns the emission center of the light emitting diode 141 with the center of the light guide sheet 13 in the thickness direction thereof, the emission center of the light emitting diode 141 may be aligned with the centers of the light guide sheet 13 and the spacer in the thickness direction thereof. That is, as shown in FIG. 9A, the emission center of the light emitting diode 141 may be aligned with the center of the total thickness of the light guide sheet 13 and the transparent spacer 56. Specifically, as shown in FIG. 9B, the light guide sheet 13 and the transparent spacer 56 face the light source unit 14, with the side surface of the light guide sheet 13 being flush with the side surface of the transparent spacer 56 transmitting light, and the center X of the light guide sheet 13 and the transparent spacer 56 in the thickness direction thereof is aligned with the emission center of the light emitting diode 141.

In this case, the spacer 56 also has a sufficient thickness to align the emission center of the light emitting diode 141 with the center X of the light guide sheet 13 and the transparent spacer 56 in the thickness direction thereof. Therefore, the thickness of the spacer 56 is appropriately set in consideration of the thickness of the light guide sheet 13 and the emission center of the light emitting diode 141 provided on the base 11. In addition, the spacer 56 is formed of a transparent material. In this way, the spacer 56 and the light guide sheet 13 can serve as a light guide member. In this case, the spacer 56 may be formed of the same material as that forming the light guide sheet 13 or ABS resin.

It is preferable that the spacer 56 has an inclined plane 56a that is tapered in the direction in which light emitted from the light emitting diode 141 travels. The inclined plane 56a makes it possible to effectively guide light into the light guide sheet 13 without emitting light traveling in the spacer 56 to the outside. As a result, it is possible to effectively use light to illuminate the light emitting regions.

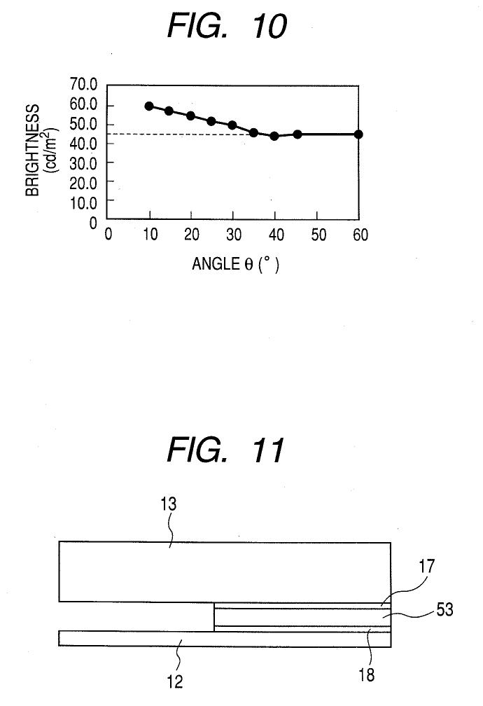

Next, the influence of an angle θ formed between the light guide sheet 13 and the inclined plane 56a in a cross-sectional view of FIG. 9B on the brightness will be described below. The influence of the angle θ on the brightness is measured by a ray tracing simulation using ZEMAX(registered trademark)-EE. Specifically, a light guide sheet having three rows by seven columns of light emitting regions, each having a thickness of 0.2 mm, a diffusion diameter of 2.25 mm, and a diffusion probability of 0.15, is prepared, and the spacer 56 having a thickness of 0.25 mm and an angle θ in the range of 10° to 90°, which is shown in FIG. 9B, is prepared. Then, as shown in FIG. 2A, when light emitted from the light source is incident on the side surfaces of the light guide sheet and the spacer, the brightness of light emitted from light emitting regions is examined. In this case, the light guide sheet and the spacer face the light source unit, with the side surface of the light guide sheet being flush with the side surface of the spacer, and the center of the light guide sheet and the spacer in the thickness direction thereof is aligned with the emission center of the light source. In addition, two white LEDs, NESW020A (made by NICHIA CORPORATION), are used as the light source, a current of 5 mA (a total of 10 mA) flows through each white LED (0.25 lm per LED), and the number of rays is one hundred thousand. The results of the examination are shown in FIG. 10.

As a comparative example, a light guide sheet without a spacer is prepared, and the brightness of light emitted from light emitting regions of the light guide sheet is examined. As the results of the examination, a brightness of 45 cd/m² is measured. As can be seen from FIG. 10, when the angle θ between the light guide sheet 13 and the inclined plane 56a is about 30° or more, light traveling within the spacer is guided into the light guide sheet without being emitted to the outside. Therefore, light can be effectively emitted from the light emitting regions, and thus the brightness can be improved.

In the illuminating unit according to this embodiment, as shown in FIG. 11, the spacer 53 is interposed between the contact sheet 12 and the light guide sheet 13, and the spacer 53 is adhered to the contact sheet 12 and the light guide sheet 13, which makes it possible to prevent the positional the positional deviation of the light guide sheet 13. In this way, it is possible to improve the brightness of light emitted from the illuminating unit. In this case, the spacer 53 is adhered to the light guide sheet 13 by an adhesive 17, and the spacer 53 is adhered to the contact sheet 12 by an adhesive 18. The adhesive 17 is appropriately selected according to a material forming the light guide sheet 13. For example, when the light guide sheet 13 is formed of a silicon resin, a silicon-based adhesive is used as the adhesive 17. When the light guide sheet 13 is formed of a urethane resin, an acryl-based adhesive is used as the adhesive 17. Meanwhile, it is preferable that an acryl-based adhesive be used as the adhesive 18.

Next, still another embodiment of the disclosure will be described in detail with reference to the accompanying drawings. In this embodiment, the same components as those shown in FIGS. 1 to 7 are denoted by the same reference numerals, and a detailed description thereof will be omitted. In addition, in the following description, the cover member 15 is omitted.

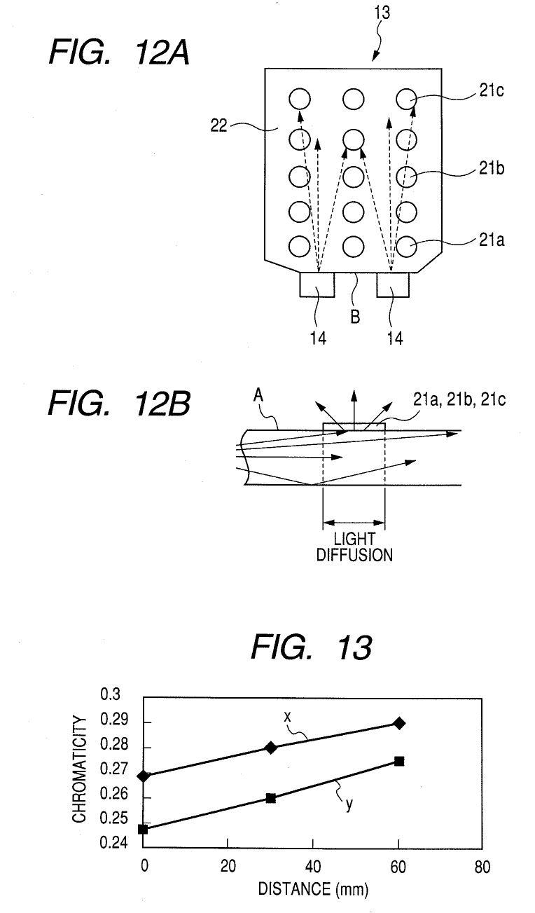

FIGS. 12A and 12B are diagrams illustrating an illuminating unit according to still another embodiment. Specifically, FIG. 12A is a plan view illustrating the illuminating unit, and FIG. 12B is a partial side view illustrating the illuminating unit.

As shown in FIGS. 12A and 12B, a light guide sheet 13 includes a side surface B and a main surface A. A light source 14 is provided on the side surface B of the light guide sheet 13. For example, a light emitting diode (LED) is used as a light source 14. In this embodiment, a white LED light source using a blue LED is used.

A plurality of light emitting regions 21 (21a, 21b, and 21c) that emit light incident from the light source 14 through the side surface B are provided on the main surface A of the light guide sheet 13. The light emitting regions 21 are provided by roughing the main surface or forming a layer made of a reflective material (for example, a white ink). In this embodiment, the light emitting regions 21 are formed of a layer made of a reflective material. As shown in FIG. 12B, the light emitting regions 21 reflect (diffuse) light traveling within the light guide sheet 13 to the outside. Then, a viewer can view the emitted light. In addition, on the main surface A of the light guide sheet 13, regions other than the light emitting regions 21 are non-emission regions 22 that do not transmit light.

The light emitting regions 21 include a correcting material having a color corresponding to the color of light absorbed by the material forming the light guide sheet 13. The material forming the light guide sheet 13 has a property capable of absorbing light components in the wavelength range of 400 nm to 500 nm (blue light component) and converting the absorbed light component into yellow. Therefore, in this case, a blue correcting material is used as the correcting material. For example, ink or pigment may be used as the correcting material. In this case, the light emitting regions 21 may be provided by forming a layer made of a mixture of a reflective material and a correcting material by, for example, printing, or they may be provided by individually forming a reflective material layer and a correcting material layer by, for example, printing.

As described above, when the light guide sheet 13 absorbs a specific light component, the amount of light absorbed depends on the distance from the light source 14. That is, in FIG. 12A, the amount of light components absorbed depends on the distance from the light source 14. Therefore, the amounts of light absorbed by the light emitting regions 21a, 21b, and 21c are different from each other. As a result, the light emitting regions emit different color light components, which makes it difficult to emit uniform color light from the entire surface of the sheet body.

However, in this embodiment, the light emitting regions 21 are formed of a mixture of a reflective material and a correcting material, that is, the light emitting regions 21 are formed of a mixture of a white material and a blue correcting material (in this embodiment, a blue pigment) in order to supplement a blue component absorbed. Therefore, it is possible to prevent the absorption of the blue component and thus prevent a variation in the color of light emitted from the light emitting regions. The content of a correcting material in the reflective material is preferably in a range of about 0.001 wt % to about 2 wt %.

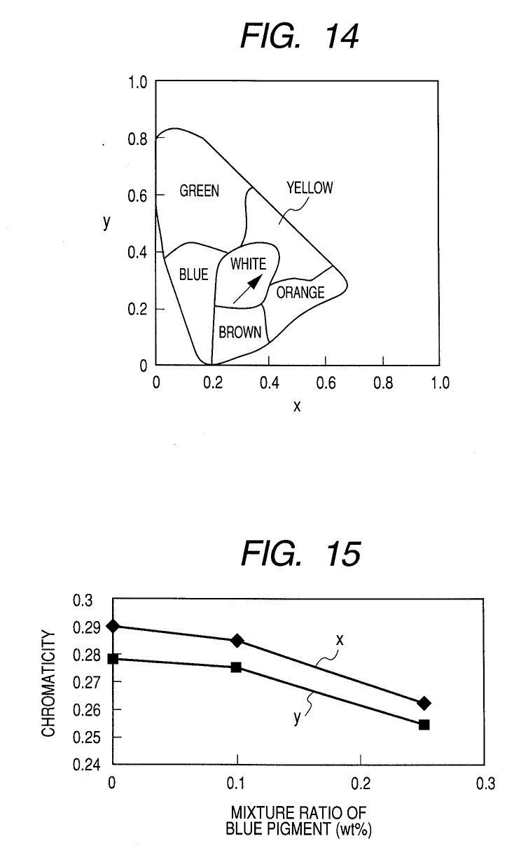

In this embodiment, the relationship between the distance from the light source 14 and the chromaticity of light at that point is examined, and the results of the examination are shown in FIG. 13. That is, as can be seen from a chromaticity table, the chromaticities of both an x component and a y component increase with an increase in the distance. This means that chromaticity moves in the direction of an arrow in the chromaticity table shown in FIG. 14, that is, chromaticity is changed to yellow, as the distance from the light source 14 increases. In addition, the relationship between the content of the correcting material (blue pigment) in the reflective material and the chromaticity of light emitted is examined, and the results of the examination are shown in FIG. 15. That is, as the content of the correcting material in the reflective material increases, both the x component and the y component decrease in the chromaticity table. This means that the chromaticity moves in the direction of an arrow in the chromaticity table shown in FIG. 14, that is, the chromaticity is changed to white, as the content of the correcting material in the reflective material increases. As can be seen from FIG. 15, 0.18 wt %/60 mm of pigment is needed to return the x component to its original color, and 0.3 wt %/60 mm of pigment is needed to return the y component to its original color. Therefore, it is possible to correct the color of light by adding 0.003 wt %/mm to 0.005 wt %/mm of correcting material.

For this reason, it is preferable that the correcting material contained in the light emitting regions 21 become larger as the distance between the light emitting region 21 and the side surface of the light guide sheet on which light is incident, that is, as the distance between the light emitting regions 21 and the light source 14 increases. Specifically, in FIG. 12A, the light emitting region 21a contains the largest amount of correcting material, followed by the light emitting region 21b and the light emitting region 21c. In this way, it is possible to reliably prevent a variation in the color of light.

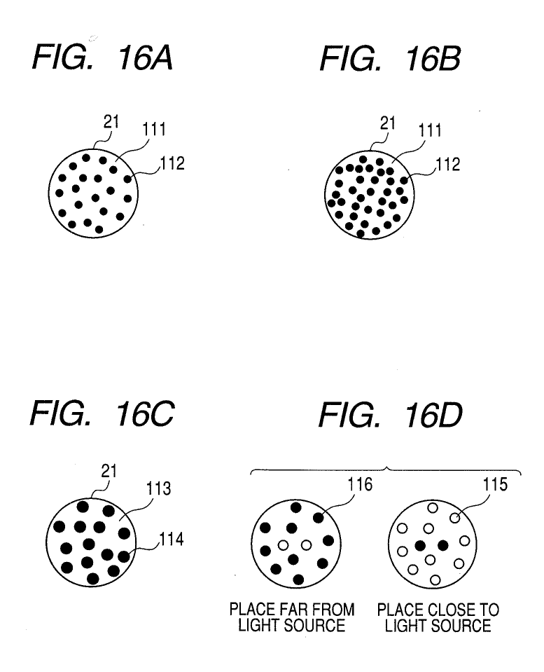

In the light emitting regions 21, as shown in FIG. 16A, when a reflective material 111 contains a correcting material 112, that is, when the light emitting regions 21 are formed of a mixture of the reflective material 111 and the correcting material 112, it is preferable to increase the volumes of the light emitting regions 21 in order to increase the amount of correcting material contained in the mixture, that is, in order to increase the ratio of the correcting material. Therefore, as shown in FIG. 16B, it is preferable to increase the amount of correcting material 112. In addition, as shown in FIG. 16C, when a reflective material layer 113 and a correcting material layer 114 are individually formed, the area or volume of the correcting material layer 114 is increased in order to increase the amount of correcting material contained in the mixture, that is, in order to increase the ratio of the correcting material. For example, when screen printing is used to form the light emitting regions, a screen printing mask having a pattern in which the area of the correcting material layer 114 increases according to the distance from the light source is made, and two printing processes including the screen printing of the reflective material layer 113 are performed to form a light guide sheet capable of emitting uniform light from the entire surface thereof. In addition, as shown in FIG. 16D, reflective material dots 115 and correcting material dots 116 may be individually formed.

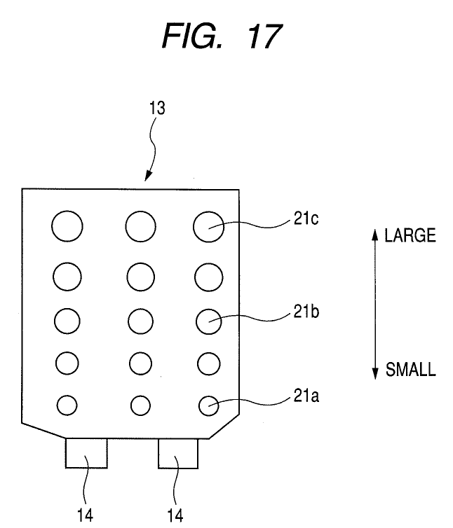

Further, the light emitting regions 21 may be provided such that, as the distance between the light emitting region 21 and the side surface of the light guide sheet on which light is incident, that is, the distance between the light emitting region 21 and the light source 14 increases, the area of the light emitting region 21 increases. Specifically, as shown in FIG. 17, the light emitting region 21c has the largest area, followed by the light emitting region 21b and the light emitting region 21a. In this way, it is possible to reliably prevent a variation in the color of light emitted. Therefore, it is possible to supplement a reduction in the brightness of light due to a large distance from the light source 14, and prevent a variation in the color of light and thus a variation in the brightness of light.

Next, examples for clarifying the effects of the invention will be described below.

As Example 1, a mixture of a white ink and 0.1 wt % of blue pigment is printed on a main surface of a sheet body formed of a polyurethane resin by screen printing to form light emitting regions, thereby manufacturing a light guide sheet. As Example 2, a mixture of a white ink and 0.25 wt % of blue pigment is printed on a main surface of a sheet body formed of a polyurethane resin by screen printing to form light emitting regions, thereby manufacturing a light guide sheet. In addition, as a comparative example, a white ink is printed on a main surface of a sheet body formed of a polyurethane resin by screen printing to form light emitting regions, thereby manufacturing a light guide sheet.

In this case, the white ink containing 49.9 vol % of R-580 (made by ISHIHARA SANGYO, CO., LTD.), 27.8 vol % of Byron 200 (TOYOBO CO., LTD.), 22.4 vol % of Byron 560 (TOYOBO CO., LTD.) is used, and LIONEL BLUE FG-7350 (made by TOYO INK) is used as the blue pigment.

A variation in the color of light (x component) emitted from the entire surface of the light guide sheet is examined. The variation in the color of light is measured by SR-3 (made by TOPCON CORPORATION) and Risa-Color (made by HI-LAND CO., LTD.) under the conditions of a viewing angle of 1° and a distance of 500 mm. As the results of the examination, in the light guide sheets according to Examples 1 and 2, the variation in the color of light is 0.007, which shows that there is little variation in the color of light. However, in the light guide sheet according to the comparative example, the variation in the color of light is 0.02, which shows that there is a little variation in the color of light.

The invention is not limited to the above-described embodiments, but various modifications and changes of the invention can be made without departing from the scope and spirit of the invention. For example, the structure of the operation region of the base, the dimensions of the components, and materials for forming the components can be appropriately changed without departing from the effects of the invention. In addition, the invention can be changed in various ways without departing from the object of the invention.

1. An illuminating unit comprising:
a base;
a light guide sheet that includes a main surface and a side surface, and is provided on the base;
a light source that is disposed in the vicinity of the side surface of the light guide sheet; and
a cover member that is provided so as to cover at least a gap between the light source and the side surface of the light guide sheet, and reflects, to the light guide sheet, light components that are not incident on the side surface of the light guide sheet.

2. The illuminating unit according to claim 1,
wherein the light guide sheet is provided on the base directly.

3. The illuminating unit according to claim 1,
wherein the light guide sheet is provided on the base with a predetermined sheet interposed therebetween.

4. The illuminating unit according to claim 1,
wherein the cover member includes a light absorbing layer that absorbs the light components that are not incident on the side surface of the light guide sheet.

5. The illuminating unit according to claim 1,
wherein the cover member is adhered to the main surface of the light guide sheet by an adhesive.

6. The illuminating unit according to claim 1, further comprising:
a spacer that is provided between the light guide sheet and the base and has a sufficient thickness to align an emission center of the light source with the center of the light guide sheet in the thickness direction thereof.

7. The illuminating unit according to claim 6,
wherein the spacer is formed of a transmissive material.

8. The illuminating unit according to claim 7,
wherein the emission center of the light source is aligned with the center of the light guide sheet and the spacer in the thickness direction thereof.

9. The illuminating unit according to claim 7,
wherein the spacer has an inclined plane that is tapered in a direction in which light emitted from the light source travels, and
an angle formed between the light guide sheet and the inclined plane is about 30° or more in a cross-sectional view.

10. The illuminating unit according to claim 1,
wherein the light guide sheet further includes a plurality of light emitting regions that are provided on the main surface and emit light incident from the side surface, and
the light emitting regions are formed of a reflective material containing a correcting material having a color corresponding to the color of light absorbed by a material forming a sheet body.

11. The illuminating unit according to claim 10,
wherein the light emitting region has a larger amount of correcting material as it becomes more distant from the side surface on which light is incident.

12. The illuminating unit according to claim 10,
wherein the light emitting region has a larger area as it becomes more distant from the side surface on which light is incident.
